(19) United States
(12) Patent Application Publication
(10) Pub. No.: US 2010/0159160 A1
(43) Pub. Date: Jun. 24, 2010

(54) MODULAR DISPLAY SYSTEM

(75) Inventors: Barbara J. Basile, Middletown, VA (US); Kerri Sue Waneka, Lakewood, CO (US)

Correspondence Address: HOLLAND & HART, LLP, P.O BOX 8749, DENVER, CO, 80201, US

(73) Assignee: DEJAJUJU, LLC, Pine, CO (US)

(21) Appl. No.: 12/642,579

(22) Filed: Dec. 18, 2009

Related U.S. Application Data
(60) Provisional application No. 61/139,340, filed on Dec. 19, 2008.

(51) Int. Cl. B32B 3/02; B32B 3/14; B23P 11/00

(52) U.S. Cl. 428/14; 428/44; 29/428

(57) ABSTRACT

A modular display system including a plurality of display tiles insertable into slideways in a display tile holder. Each display tile includes a display panel, a slide panel, and a spacer extending therebetween. The display tile holder includes a base panel and a plurality of first slideways and a plurality of second slideways orthogonal to the first. The display tile holder includes a plurality of retainers each supported in spaced relation from the base panel and arranged in an array to define the slideways. Multiple display tile holders are joined together with a connector that engages connector sockets disposed on the base panel. Preferably, the display tile holders are connected together such that at least one slideway from each of the display tile holders is aligned with another slideway. The modular display system may include mounts attachable to a vertical surface and operative to support the display tile holders.

### CROSS REFERENCE TO RELATED APPLICATIONS

This application claims the benefit of U.S. Provisional Application No. 61/139,340, filed Dec. 19, 2008, the disclosure of which is hereby incorporated by reference in its entirety.

### BACKGROUND

People enjoy expressing themselves in many different ways. For instance, many people enjoy scrapbooking, which is the collecting and mounting in a book, of various photographs, keepsakes, and “scraps” of everyday life. Another example of self expression that has recently gained popularity is known as refrigerator magnet poetry. Small magnets with words printed on them are placed on the refrigerator wherein people enjoy rearranging the words to create various entertaining sayings and poetry. A collage is yet another popular form of self expression. A collage is an artistic creation derived from a collection of pictures cut from magazines and printed words cut from newspapers, for example. The selected pictures and words are arranged and affixed to a substrate to convey a message or feeling.

Another very popular form of personal expression is the display of one's favorite photographs. The selection of the particular photograph and the choice of display means both express a certain amount of creativity. For instance, simply tacking a photograph to a wall has a different meaning than mounting a photo in, for example, a wooden frame and matting of a selected color.

While the various means of expressing oneself as noted above fulfill their purpose and have become very popular, there is still a need to raise the level of self-expression to an art form that anyone can create and enjoy. Furthermore, there is a need for self-expression that is no longer static but can be dynamically changed as one's personal creativity is inspired.

### SUMMARY

Provided herein is a modular display system that allows anyone to create and enjoy artwork that can be dynamically changed as one's personal creativity is inspired. The modular display system includes a plurality of display tiles which may be inserted into slideways in a display tile holder. Each display tile includes a display panel, a slide panel, and a spacer extending therebetween. As an example and without limitation, ceramic artwork or a photograph holder may be disposed on the display panel.

The display tile holder includes a base panel and a plurality of first slideways and a plurality of second slideways orthogonal to the first. Each slideway is sized and configured to slideably receive the slide panel of the display tiles. The display tile holder includes a plurality of retainers each supported in spaced relation from the base panel and arranged in an array to define the slideways. The slideways may also include an end stop to retain the display tiles in the slideway. A frame member may be installed on a perimeter of the display tile holder, which may also act as an end stop for the slideways. The display tile holders may be a unitary molded construction, for example.

Multiple display tile holders may be joined together. A connector socket is disposed proximate an edge of the base panel and a connector that is adapted to engage the connector sockets holds the display tile holders together. Preferably, the display tile holders are connected together such that at least one slideway from each of the plurality of display tile holders is aligned with another slideway. The modular display system may also include a plurality of mounts attachable to a vertical surface and operative to support the display tile holders. The mounts may be comprised of display tiles.

A modular display system kit is also disclosed herein. The kit includes a plurality of display tiles, a plurality of display tile holders, and a plurality of mounts attachable to a vertical surface and operative to support the display tile holders. The kit also includes a template for use in locating the mounts in an array whereby the display tile holders may be dynamically and selectively positioned on the vertical surface. The template comprises paper and center marks.

Also contemplated is a method of composing and displaying artwork. The method comprises providing a plurality of display tiles that include artwork along with a display tile holder that includes a plurality of first slideways and a plurality of second slideways that are orthogonal to the first. A subset of the display tiles is selected and slideably engaged into the slideways. One or more of the display tiles may be removed from the holder and replaced with another of the plurality of display tiles. As mentioned above additional display tile holders may be adjoined with the first. Furthermore, one or more of the display tiles may be slid from the first display tile holder to another display tile holder or within the same display tile holder, whereby a user may dynamically compose and display artwork.

These and other objects of the modular display system will become more readily appreciated and understood from a consideration of the following detailed description of the exemplary embodiments when taken together with the accompanying drawings, in which:

### BRIEF DESCRIPTION OF THE DRAWINGS

FIG. 1 is a perspective view of a modular display system according to a first exemplary embodiment that includes illustrative artwork and indicia;

FIG. 2 is a perspective view of the modular display system as shown in FIG. 1 with the artwork and indicia removed along with one of the tiles;

FIG. 3 is a perspective view of a tile holder that may be provided as a component to the modular display systems shown in FIGS. 1-2;

FIG. 4 is a rear perspective view of an exemplary embodiment of a display tile that may be used with the modular display systems;

FIG. 5 is a rear perspective view of the tile holder showing tiles attached in a wall hanging configuration;

FIG. 6 is a rear perspective view of the tile holder as shown in FIG. 5 including tiles for use in hanging the display module;

FIG. 7 is a partially exploded front perspective view of a modular display system according to a second exemplary embodiment;

FIG. 8 is a front perspective view of the tile holder shown in FIG. 7;

FIG. 9 is a front perspective view of a display tile shown in FIG. 7;

FIG. 10 is a rear perspective view of a display tile shown in FIGS. 7 and 9;

FIG. 11 is a perspective view illustrating one embodiment of the modular display system that combines two separate tile holders;

FIG. 12 is an enlarged, partial perspective view of a connection point between the two tile holders shown in FIG. 11;

FIG. 13 is an enlarged, partial perspective view of the connection point shown in FIG. 12;

FIG. 14 is an enlarged perspective view of one embodiment of a connector that may be used to secure a connection point shown in FIGS. 11-13;

FIG. 15 is a rear perspective view of one embodiment of a tile holder that may be used with the modular display system;

FIG. 16 is a rear perspective view of the tile holder as shown in FIG. 15 including tiles for use in hanging the display module;

FIG. 17 is a perspective view of three display modules joined in an illustrative wall hanging configuration;

FIG. 18 is a partial perspective view of a layout template that may be used in mounting one or more display modules to a wall; and

FIG. 19 is a perspective view illustrating an article of furniture and a portion of flooring both including display modules.

### DETAILED DESCRIPTION

In the following detailed description, reference is made to the accompanying drawings which form a part hereof, and in which is shown by way of illustrations specific embodiments for practicing the invention. The embodiments illustrated by the figures are described in sufficient detail to enable those skilled in the art to practice the invention, and it is to be understood that other embodiments may be utilized and changes may be made without departing from the spirit and scope of the present invention. The following detailed description is, therefore, not to be taken in a limiting sense.

Disclosed herein is a modular display system that provides a user with the tools to create an artful and symbolic reflection of one's personal intent in the form of a visual mantra or affirmation of creative energy and expression. The modular display system is broadly comprised of a plurality of displayed tiles and at least one tile holder. The display system is a modular and scalable way to exhibit works of art comprising decorative ceramic, glass, acrylic glass tiles, wood, metal, and molded plastic, to name just a few.

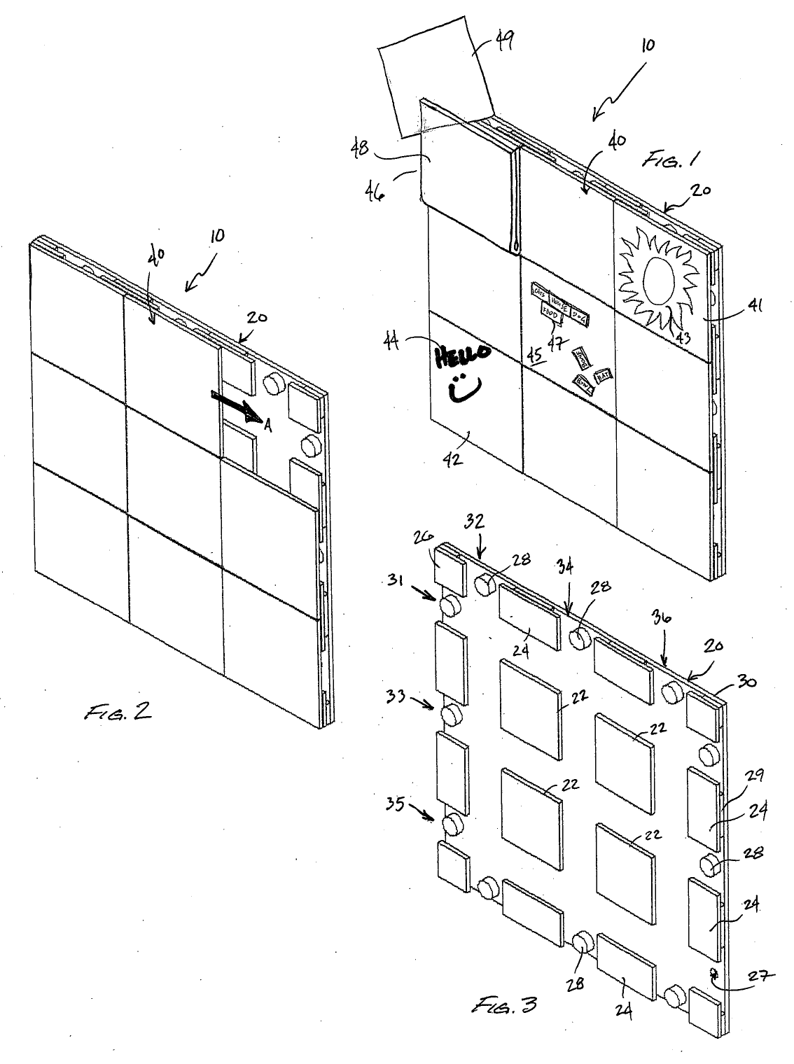

A first exemplary embodiment of the modular display system 10 is shown in FIG. 1. Modular display system 10 includes a plurality of display tiles 40 and tile holder 20. Each tile 40 may include indicia printed directly on the tile or it may be the foundation for other indicia or artwork. For instance, display tile 41 includes indicia 43, shown here in the form of a flower. In this case, the flower may be silk-screened onto the tile or may be a ceramic relief attached to the tile. Display tile 42 is in the form of a dry erase board with exemplary indicia 44. This type of board may be written upon and erased many times. Tile 45 is comprised of a ferrous material which allows magnets 47 to adhere to the tile. In this case magnets 47 are in the form of magnet poetry. However, other refrigerator magnets may also be adhered to this type of tile. Tile 46 includes a photograph holder 48 comprised of an acrylic sheet material that has been folded over on itself forming a holder for retaining a photograph 49, for example. These are but a few examples of the types of indicia and artwork which may be applied to tiles 40 for use in the modular display system. Other examples of media that the display tiles may include are carved wood, metal, sculpted ceramic, printed material, printed glass, textiles, and the like.

FIG. 2 shows a display module 10 with one tile removed. As can be appreciated in this figure, with a tile removed the remaining tiles may be repositioned relative to each other. For example, tile 40 may be slid along tile holder 20 in the direction of arrow ‘A’. Thus, the modular display system provides a dynamic display of indicia and artwork applied to tiles 40. The structure of tile holder 20 is perhaps best shown in FIG. 3. In this embodiment tile holder 20 includes a base panel 30 that supports a plurality of retainers 22, 24, and 26. Each retainer is supported in spaced relation relative to base panel 30. For instance, retainers 24 are supported by spacers 29. Retainers 22, 24, and 26 are placed in spaced apart relation to one another forming horizontal (31, 33, 35) and vertical (32, 34, 36) slideways. These slideways are sized and configured to receive display tiles 40 therealong. A stop member 28 is removably disposed at the end of each slideway in order to prevent tiles 40 from falling out of tile holder 20. Stop members 28 may be fastened to base panel 30 by any suitable means such as fasteners, adhesives, and the like. Alternatively, stop members 28 may be pressed into receptacles 27. One ordinarily skilled in the art will recognize that tile holder 20 may be constructed from various materials such as plastic, metal, wood, cardboard, and the like. In one particular embodiment, however, tile holder 20 as well as tiles 40 are constructed from recycled plastic materials. It should also be understood that while display module 10 is shown in a 3×3 configuration, other configurations with respect to size and number of rows and columns are contemplated as well.

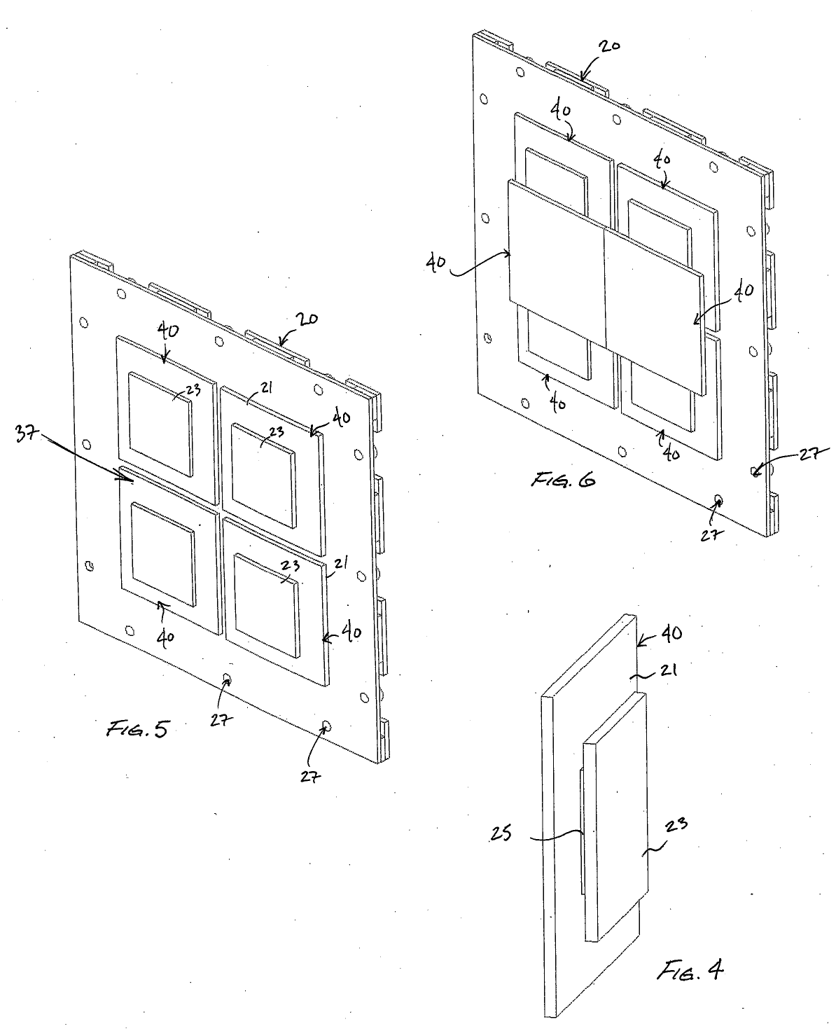

FIG. 4 illustrates the display tile 40 in more detail. Tile 40 includes display panel 21, a slide panel 23, and a spacer panel 25 disposed therebetween. It should be appreciated that slide panel 23 is sized and configured to fit between opposed retainer spacers 29. Similarly, spacer panel 25 is sized and configured to fit between opposed retainers 22, 24, and 26. Accordingly, slider panel 23 may be slidably received in any of slideways 31-36. Furthermore, sliders 23 are captured under retainers 22, 24, and 26, thereby retaining tiles 40 in tile holder 20.

FIG. 5 shows display module 10 as viewed from the back with tiles 40 attached in an array to create mounting slideway 37. With further reference to FIG. 6, mounting slideway 37 is sized and configured to receive additional tiles 40, which may be mounted to a wall or other vertical surface. Thus, tiles 40 have versatility in that they may be used to display artwork and indicia as well as for mounting the module itself. When mounting a module or modules the tiles may be mounted to a wall with fasteners, double-sided tape, or adhesive, to name just a few.

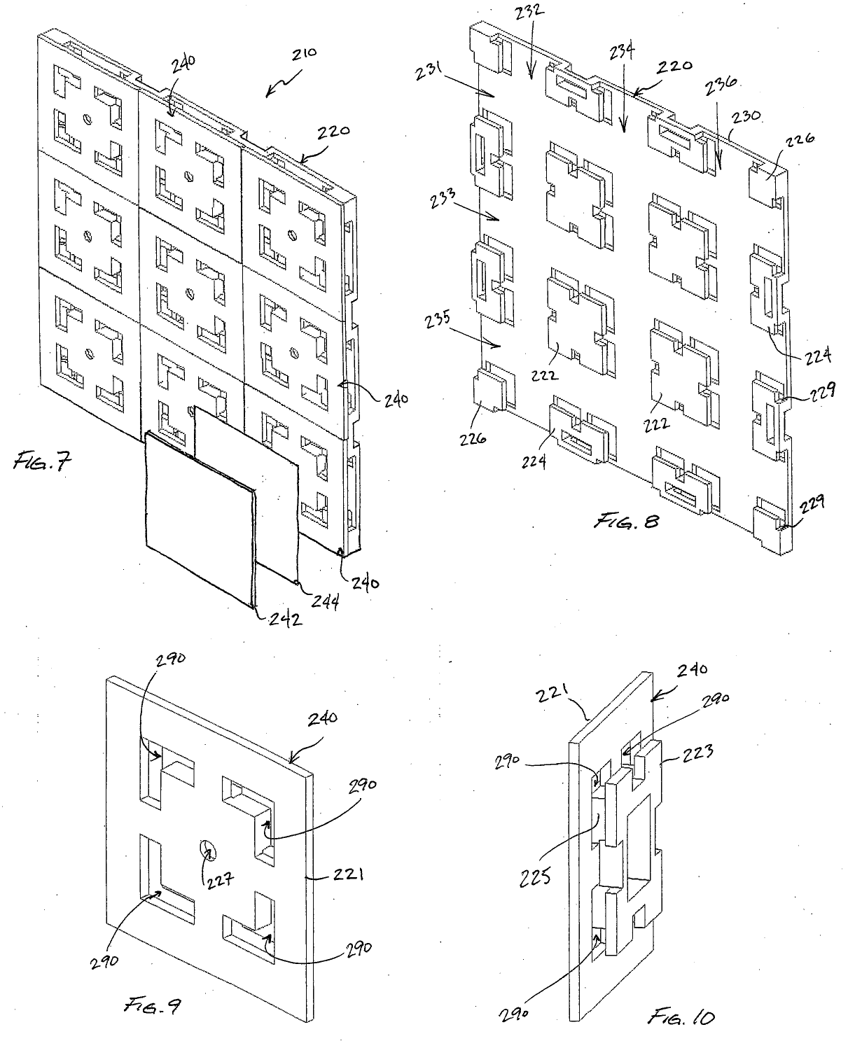

FIG. 7 illustrates modular display system 210 according to a second exemplary embodiment. With further reference to FIG. 8, it can be seen that tile holder 220 is configured similarly to the first embodiment as described above. However, in this embodiment, tiles 240 and tile holder 220 are configured to facilitate manufacturing the modules by an injection molding process. As such, retainers 222, 224, and 226 are integrally molded with base panel 230. Each retainer is supported in spaced relation to base panel 230 by an associated extension 229. Here again, retainers 222, 224, and 226 are placed in spaced apart relation to one another forming horizontal (231, 233, 235) and vertical (232, 234, 236) slideways.

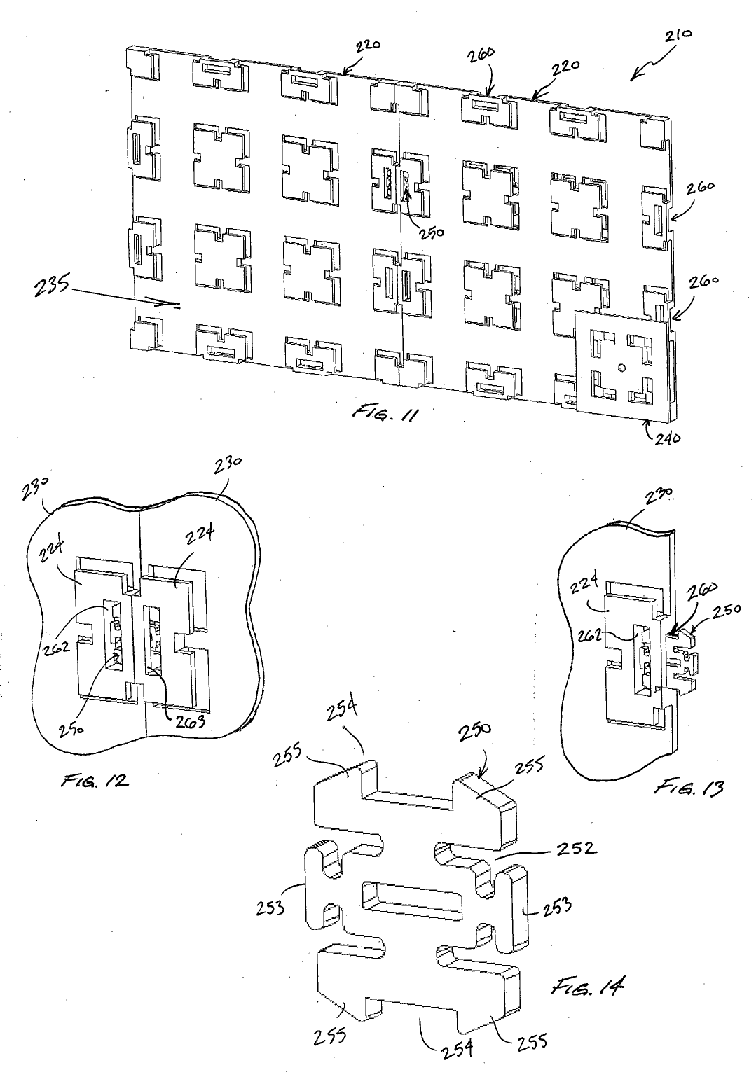

Referring to FIGS. 9 and 10 it can be seen that tile 240 is of a unitary construction including display panel 221, slide panel 223, and extension 225 extending therebetween. Display tile 240 also includes an aperture 227 formed therethrough, which may be used to attach artwork, indicia, or the like. Also, aperture 227 is sized and configured to receive a fastener for facilitating mounting the module onto a wall as is described more fully below. Returning briefly to FIG. 7, artwork or indicia 242 may also be attached to tile 240 with a suitable double-sided tape 244.

In order to facilitate injection molding tile 240 and tile holder 220 have a unique construction that can be appreciated with reference to tile 240 shown in FIGS. 9 and 10. Normally it would be difficult if not impossible to integrally mold extension 225 with the rest of tile 240. However, as shown here tile 240 includes openings 290 that are formed by interlocking portions of the mold. This design also reduces the volume of plastic required to form the tile; thus, conserving resources, both monetary and environmental.

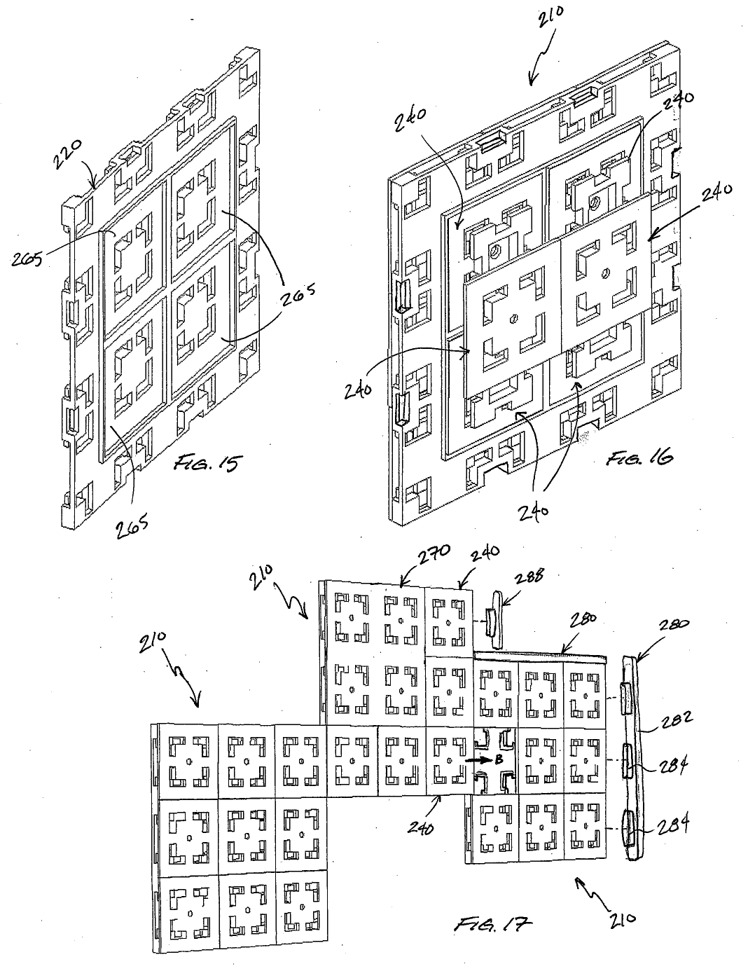

FIG. 11 illustrates two tile holders 220 joined in combination at a connection point with connector 250. Connector 250 engages sockets 260 located around the perimeter of each tile holder 220. Not only are tile holders 220 joined, but their respective slideways are also joined. Thus for example, slideway 235 extends across both tile holders. Accordingly, tile 240 may be positioned anywhere along slideway 235. With reference to FIGS. 12-14, it can be appreciated that perimeter retainers 224 each include a socket 260 sized and adapted to receive a connector 250. Connecter 250 includes a medial spacer portion 252 with adjoining lateral clip portions 254. Each clip portion 254 includes a pair of ramped teeth 255. Spacer portion 252 includes opposed foot surfaces 253, which confront the bottoms 262 of sockets 260. Teeth 255 are operative to engage socket wall 263. Preferably, connector 250 is formed of a resilient material such as plastic, so that connector clips 254 snap into sockets 260 and teeth 255 engage socket walls 263. The connection points may also be secured by other suitable means such as other embodiments of connector 250, fasteners, double sided tape, glue, and integrally formed clips, to name a few.

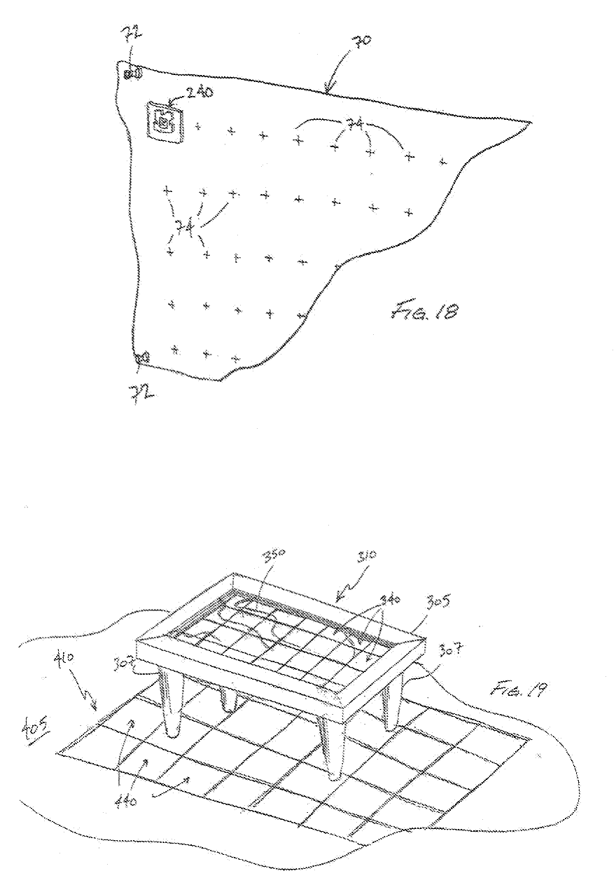

Tile holder 220 includes a plurality of pockets 265 sized and configured to receive display panels 221 of tiles 240. With reference to FIGS. 15 and 16 it can be appreciated that the same tiles used for displaying artwork and indicia may also be fitted into pockets 265 to create a slideway for receiving additional tiles 240 for use in hanging the display module.

FIG. 17 further illustrates the versatility of the disclosed display system. For example, in this case there are three display modules 210 joined together using connectors 250 as described above. Once the modules are joined, tiles 240 may be repositioned between tile holders. For example, tile 240 may be slid along arrow ‘B’ from one tile holder to the other. It should also be noted that various configurations of tiles are contemplated. For example, tile 270 is a single large tile covering the same space as 4 of the smaller tiles 240 arranged in a 2×2 configuration. Accordingly, tile 270 can accommodate larger items for display.

Also shown in FIG. 17 are frame members 280, which may be installed around the perimeter of the combined modules to provide a finished border. These frame members may also be used to contain tiles 240 in the tile holder slideways. Frame members 280 include an elongate portion 282 with tongues 284 extending therefrom. Each tongue 284 is configured to engage a respective slideway. Frame member 280 may be formed of a resilient material such that tongues 284 are maintained in the slideways with a friction fit. Alternatively, tongue 284 could include a clip arrangement such as described with respect to connector 250. Preferably, frame members 280 are constructed from a resilient material, such as rubber, so that they may be cut to length in order to accommodate various perimeter portions of combined modules. For example, frame member 288 may be cut from frame member 280.

FIG. 18 is an illustration of a template 70, which may be used to facilitate the installation of multiple display modules 210 on a surface, such as a wall. Template 70 may be temporarily affixed to a vertical surface with thumbtacks 72, for example. Template 70 includes center-point marks 74, which indicate the proper spacing for tiles 240 that are to be used in mounting modules to the surface. An ordinarily skilled artisan will appreciate that an array of properly spaced tiles 240 attached to a surface will provide a grid of horizontal and vertical slideways along which modules may be positioned and repositioned much like the tiles are repositionable on the tile holders.

While the various embodiments have been shown generally with respect to a wall hanging system, as shown in FIG. 19 the display system may be incorporated into, for example, a coffee table 310 or a flooring system 410. Coffee table 310 includes a top portion 305 supported by legs 307. Top portion 305 includes display tiles 340, which are protected or covered by a transparent cover 350. Transparent cover 350 could be glass, acrylic material, or the like. Similarly, floor system 410 could be countersunk into floor 405. Both coffee table 310 and floor 410 utilize the concepts for display modules as described above. The coffee table and floor systems could include the combination of multiple modules to create the desired shape and size of top portion 305 or floor system 410. Alternatively, one large module could be used for the desired area. Also, larger tiles may be used for different applications. For instance, larger tiles may be desirable for a floor installation.

Methods relating to the above described modular display system are also contemplated. The methods thus encompass the steps inherent in the above described mechanical structures. Broadly, one method could include the step of providing a plurality of display tiles that include artwork along with a display tile holder that includes a plurality of orthogonal slideways. A subset of the display tiles is selected and slideably engaged into the slideways. One or more of the display tiles may be removed from the holder and replaced with another of the plurality of display tiles. As mentioned above additional display tile holders may be adjoined with the first. Furthermore, one or more of the display tiles may be slid from the first display tile holder to another display tile holder or within the same display tile holder, whereby a user may dynamically compose and display artwork.

Accordingly, the modular display system has been described with some degree of particularity directed to the exemplary embodiments thereof. It should be appreciated that the contemplated display system is defined by the following claims construed in light of the prior art so that modifications or changes may be made to the exemplary embodiments without departing from the concepts contained herein.

We claim:

1. A modular display system, comprising:
a plurality of display tiles, each including:
a display panel;
a slide panel; and
a spacer extending therebetween;
a plurality of display tile holders, each including:
a base panel;
a plurality of first slideways and a plurality of second slideways orthogonal to the first, each slideway being sized and configured to slideably receive said display tiles; and
a connector socket disposed proximate an edge of said base panel; and
a connector adapted to engage said connector sockets whereby said plurality of display tile holders are connected to each other.

2. A modular display system according to claim 1 including a plurality of mounts attachable to a vertical surface and operative to support said display tile holders.

3. A modular display system according to claim 2 wherein said plurality of mounts are comprised of display tiles.

4. A modular display system according to claim 1 wherein each said display tile holder includes a plurality of retainers each supported in spaced relation from said base panel and arranged in an array to define said slideways.

5. A modular display system according to claim 1 wherein said display tile holders comprise a unitary molded construction.

6. A modular display system according to claim 1 wherein at least one slideway includes an end stop.

7. A modular display system according to claim 1 including ceramic artwork disposed on said display panel.

8. A modular display system according to claim 1 wherein said display tile includes a photograph holder.

9. A modular display system according to claim 1 including a frame member installed on a perimeter of said display tile holder.

10. A modular display system according to claim 1 wherein said plurality of display tile holders are connected together such that at least one slideway from each of said plurality of display tile holders is aligned with another said slideway.

11. A modular display system kit, comprising:
a plurality of display tiles, each including:
a display panel;
a slide panel; and
a spacer extending therebetween;
a plurality of display tile holders, each including:
a base panel;
a plurality of first slideways and a plurality of second slideways orthogonal to the first, each slideway being sized and configured to slideably receive said display tiles;
a plurality of mounts attachable to a vertical surface and operative to support said display tile holders; and
a template for use in locating said mounts in an array whereby said display tile holders may be selectively positioned on the vertical surface.

12. A modular display system kit according to claim 11 wherein said plurality of display tile holders are connected together.

13. A modular display system kit according to claim 12 wherein said plurality of display tile holders are connected together such that at least one slideway from each of said plurality of display tile holders is aligned with another said slideway.

14. A modular display system kit according to claim 13 wherein each said display tile holder includes at least one socket adapted to receive a connector whereby said plurality of display tile holders are connected to each other.

15. A modular display system kit according to claim 11 wherein said template comprises paper and center marks.

16. A modular display system kit according to claim 11 wherein each display tile holder is capable of receiving a number of display tiles that is less than said plurality of display tiles.

17. A method of composing and displaying artwork, the method comprising:
providing a plurality of display tiles each including artwork disposed thereon;
providing a first display tile holder including a plurality of first slideways and a plurality of second slideways orthogonal to the first, each slideway being sized and configured for slideably receiving said display tiles;
selecting a subset of said display tiles; and
slideably engaging said subset of display tiles into said slideways.

18. The method according to claim 17 further comprising removing one of said selected subset display tiles and replacing it with another of said plurality of display tiles.

19. The method according to claim 17 further comprising providing a second display tile holder adjoining the first and sliding one of said selected subset display tiles from the first display tile holder to the second display tile holder.

20. The method according to claim 17 further comprising mounting said display tile holder to a vertical surface.
